(19) United States
(12) Patent Application Publication
(10) Pub. No.: US 2015/0100142 A1
(43) Pub. Date: Apr. 9, 2015

(54) Audio Systems and Related Devices and Methods

(71) Applicant: Base Corporation, Framingham, MA (US)

(72) Inventors: Jamie Alders, Dover, MA (US); Keith Martin, Westborough, MA (US); Santiago Carvajal, Ashland, MA (US); David Datta, Worcester, MA (US); Christine Hostage, Southborough, MA (US)

(73) Assignee: Base Corporation, Framingham, MA (US)

(21) Appl. No.: 14/047,404

(22) Filed: Oct. 7, 2013

(51) Int. Cl. G06F 3/16; H04L 29/08

(52) U.S. Cl. CPC G06F 3/165; H04L 67/10
USPC 700/94

(57) ABSTRACT

A method for creating a stream of content for an audio system is provided. The method includes obtaining text metadata identifying each audio track of a selected collection of audio content, the selected collection of audio content being selected for playback from a first audio playback device of the audio system, and forwarding the text metadata identifying each audio track of the selected collection of audio content to a digital audio source to enable the digital audio source to select audio content containing additional audio content based on the text metadata.

### BACKGROUND

This disclosure relates to audio systems and related devices and methods, and, particularly, to creating a stream of content for an audio system.

### SUMMARY

All examples and features mentioned below can be combined in any technically possible way.

In one aspect, a method for creating a stream of content for an audio system is provided. The method includes obtaining text metadata identifying each audio track of a selected collection of audio content, the selected collection of audio content being selected for playback from an audio playback device of the audio system, the selected collection of audio content being implemented as an audio compact disc that has been selected for playback via the audio system. The method also includes forwarding the text metadata identifying each audio track of the selected collection of audio content to a digital audio source to enable the digital audio source to select additional audio content based on the text metadata for playback from the audio playback device.

In some implementations the digital audio source is an Internet music service.

In certain implementations the text metadata includes a title of the audio compact disc, and track information for each audio track on the audio compact disc.

In some implementations the text metadata includes a track title and artist name for each audio track on the audio compact disc.

In certain implementations the method further includes forwarding a table of content of the collection of audio tracks to an audio database, and receiving, from the audio database, the text metadata.

In some implementations the method further includes fingerprinting the selected collection of audio content to determine track tiles and artist names of each of the plurality of audio tracks.

In certain implementations forwarding the text metadata identifying each audio track of the selected collection of audio content to a digital audio source occurs prior to completion of playing each audio track of the selected collection of audio content.

In some implementations the method further includes receiving, by the audio playback device from the digital audio source, the additional audio content.

In certain implementations the method further includes outputting audio associated with each audio track of the selected collection of audio content, and after completing the step of outputting the audio associated with each audio track of the selected collection of audio content, outputting audio associated with the additional audio content received from the digital audio source.

In one aspect, a method for creating a stream of content for an audio system is provided. The method includes obtaining text metadata identifying each audio track of a selected collection of audio content, the selected collection of audio content being selected for playback from an audio playback device of the audio system, the selected collection of audio content being implemented as a playlist of audio tracks defined by a user of the audio system that has been selected for playback from the audio playback device. The method also includes forwarding the text metadata identifying each audio track of the selected collection of audio content to a digital audio source to enable the digital audio source to select additional audio content based on the text metadata for playback from the audio playback device.

In some implementations the method also includes fingerprinting the selected collection of audio content to determine track tiles and artist names of each of the plurality of audio tracks.

In one aspect, an audio playback device configured to operably connect to a digital audio source is provided. The audio playback device includes a digital-to-analog converter configured to receive a digital representation of content and convert the digital representation of the content into analog form, an electro-acoustic transducer configured to generate audible sound from the analog form, and a processor. The audio playback device further includes instructions stored on a computer-readable media that, when executed, cause the processor to cause a digital representation of a plurality of audio tracks of a selected collection of audio content to be input to the digital-to-analog converter, and after each audio track of the selected collection of audio content is input to the digital-to-analog converter, cause additional audio content received from a digital audio source to be input to the digital-to-analog converter. The additional audio content is selected by the digital audio source based on each of the plurality of tracks of the selected collection of audio content.

In some implementations the instructions are further configured to cause the processor to obtain text metadata identifying each audio track of the selected collection of audio content, and forward the text metadata identifying each audio track of the selected collection of audio content to the digital audio source to enable the digital audio source to select the additional audio content based on the text metadata.

In certain implementations the digital audio source is an Internet music service.

In some implementations the selected collection of audio content is an audio compact disc that has been selected for playback via the audio playback device.

In certain implementations the text metadata includes a title of the audio compact disc, and track information for each audio track on the audio compact disc.

In some implementations the text metadata includes a track title and artist name for each audio track on the audio compact disc.

In certain implementations the selected collection of audio content is a playlist of audio tracks defined by a user of the audio playback device that has been selected for playback from the audio playback device.

In some implementations the audio playback device further includes instructions to cause the processor to forward a table of content of the collection of audio tracks to an Audio Database, and receive, from the Audio Database, the text metadata.

### BRIEF DESCRIPTION OF THE DRAWINGS

FIG. 1 is a schematic view of an example audio system.

FIGS. 2A and 2B are swim lane diagrams showing steps of creating a stream of content for the audio system of FIG. 1.

FIG. 3 is a block diagram of an example implementation of an audio playback device that can be utilized in the audio system of FIG. 1.

FIG. 4 is a block diagram of another example implementation of an audio playback device that can be utilized in the audio system of FIG. 1.

FIG. 5 is a block diagram of an example implementation of a controller that can be utilized in the audio system of FIG. 1.

FIG. 6 is a block diagram of an example implementation of a server that can be utilized in the audio system of FIG. 1.

### DETAILED DESCRIPTION

This disclosure is based, at least in part, on the realization that it can be beneficial to create a steam of content (such as a streaming audio radio station from an Internet audio content provider), based on a selected collection of audio content (such as on an audio compact disc) selected to be played from an audio playback device once the selected collection of audio content is over. Such feature can facilitate creation of a virtual extension to the selected collection of audio content to extend the user's enjoyment of the selected collection of audio content.

System Overview

An audio system for delivering digital audio is described in U.S. patent application Ser. No. 13/833,395, filed Mar. 15, 2013, entitled Audio Systems and Related Devices and Methods, the content of which is hereby incorporated herein by reference. In one embodiment, the system and method for creation of a stream of content may be implemented using the audio system described in greater detail in that application.

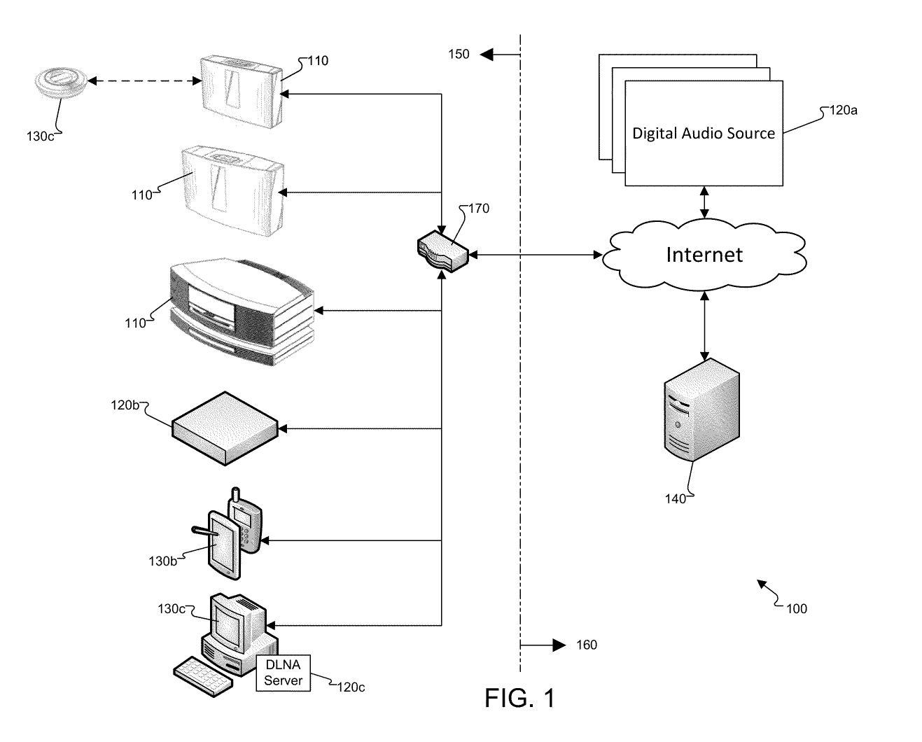

Referring to FIG. 1, an audio system 100 for the delivery of digital audio (e.g., digital music) provides for easy, quick access to a variety of digital audio sources. At a very high level, there are four main categories of devices in the audio system 100: (i) audio playback devices 110; (ii) digital audio sources 120a, 120b, 120c (collectively referenced as 120); controllers 130a, 130b, 130c (collectively referenced as 130); and a server 140.

The audio playback devices 110 are electronic devices which are capable of rendering audio content. These devices can access stored audio content (e.g., remotely stored audio content) and stream it for playback. In some cases, the audio playback devices 110 may also be capable of playing locally stored content. In other cases, the audio playback devices 110 may also be capable of playing locally accessed physical mediums, such as audio compact discs. These devices render audio with the help of audio codecs and digital signal processors (DSPs) available within.

The audio playback devices 110 can communicate with each other. For example, each audio playback device 100 can communicate with the other audio playback devices 110 within the audio system 100 for synchronization. This can be a synchronization of device settings, such as synchronization of recent and preset assignments, or, for synchronization of playback (e.g., such that all or a subset of the audio playback devices 110 play the same content simultaneously and synchronously).

The digital audio sources 120 are devices and/or services that provide access to one or more associated entities for supplying content (e.g., audio streams) to the audio playback devices 110, and which can be located remotely from the audio playback devices 110. An “entity,” as used herein, refers to a grouping or collection of content for playback. Example entities include Internet radio stations and user defined playlists. “Content” is data (e.g., an audio track) for playback. “Associated entity” refers to an entity that is associated with a particular audio source. For example, if the digital audio source 120 is an Internet music service such as Pandora®, an example associated entity would be a radio station provided by Pandora®.

For the purposes of the audio system 100, audio streams are considered to be data. They are processed as digital information that is converted to analog before presentation. Data streaming is the method by which data is moved from an audio source 120 to an audio playback device 110. Typically, there are two models for this data movement, push and pull. The audio system 100 is capable of managing this audio (data) streaming in both fashions; descriptions of these processes are as follows.

In a push model, the digital audio source 120 will move the data to the audio playback device 110 at a pace that it desires. The recipient (e.g., one of the audio playback devices 110) of the data will acknowledge the data and the digital audio source 120 will provide more data. This model requires the digital audio source 120 to be managing the throughput characteristics of the audio system 100. In a pull model, the audio playback device 110 will request data from the digital audio source 120 at a rate it desires. This allows the audio playback device 110 to read ahead if data is available.

The digital audio sources 120 each maintain a repository of audio content which can be chosen by the user to play. The digital audio sources 120 can be based on the Digital Living Network Alliance® (DLNA) or other Web based protocols similar to the Hypertext Transfer Protocol (HTTP). Some of the devices and services in this category include Internet based music services 120a such as Pandora®, Spotify®, and vTuner®; network-attached storage (NAS) devices 120b, and a media server daemon 120c (e.g., provided as a component of a computer-based controller).

The digital audio sources 120 include user defined playlists of digital music files available from network audio sources such as network-attached storage (NAS) devices 120b, and a DLNA server 120c which may be accessible to the audio playback devices 110 over a local area network such as a wireless (Wi-Fi) or wired (Ethernet) home network 150, as well as Internet radio sites 120a such as Pandora®, vTuner®, Spotify®, etc., which are accessible to the audio playback devices 110 over a wide area network 160 such as the Internet.

The controllers 130 are responsible for controlling the audio playback devices 110 and for browsing the audio sources 120 in the audio system 100. Some of the devices in this category include desktop computers, laptop computers, and mobile devices such as smart phones and tablets. These devices control the audio playback devices 110 via a wireless communication interface (e.g., IEEE 802.11 b/g, Bluetooth LE, infrared, etc.). The controllers 130 serve as an online management tool for a user's network enabled audio playback devices 110. The controllers 130 provide interfaces which enable to the user to perform one or more of the following: setup a connection to a Wi-Fi network; create an audio system account for the user, sign into a user's audio system account and retrieve information; add or remove an audio playback device 110 on a user's audio system account; edit an audio playback device's name, and update software; access the audio sources (via the audio playback devices 110); assign an entity (e.g., a playlist or radio station) associated with one of the audio sources 120 to a preset indicator; browse and select recents, where “recents” refers to recently accessed entities; use transport controls (play/pause, next/skip, previous), view “Now Playing” (i.e., content currently playing on an audio playback device 110) and album art; and adjust volume levels.

In some cases, the controllers 130 may include network controllers 130a, 130b and auxiliary controllers 130c. The network controllers 130a, 130b are controllers that communicate with the audio playback devices 110 over a wireless (Wi-Fi) network connection. The network controllers can include primary network controllers 130a and secondary network controllers 130b. The primary network controllers 130a can be utilized for: connecting an audio playback device 110 to a Wi-Fi network (via a USB connection between the audio playback device 110 and the primary network controller 130a); creating a system account for the user; setting up music services; browsing of content for playback; setting preset assignments on the audio playback devices 110; transport control (e.g., play/pause, fast forward/rewind, etc.) for the audio playback devices 110; and selecting audio playback devices 110 for content playback (e.g., single room playback or synchronized multi-room playback). Devices in the primary network controller category can include desktop and laptop computers.

The secondary network controllers 130b may offer some, but not all, of the functions of the primary network controllers 130a. For example, the secondary network controllers 130b may not provide for all of the account setup and account management functions that are offered by the primary network controllers 130a. The secondary network controllers 130b may be used for: music services setup; browsing of content; setting preset assignments on the audio playback devices; transport control of the audio playback devices; and selecting audio playback devices 110 for content playback: single room or synchronized multi-room playback. Devices in the secondary network controller category can include mobile devices such as smart phones and tablets.

The auxiliary controllers 130c communicate wirelessly (e.g., via Bluetooth low energy (BTLE) or IR) with an associated (e.g., paired) one of the audio playback devices (item 110, FIG. 1). The auxiliary controllers 130c may offer limited functionality. The auxiliary controllers 130c may be used for: browsing of content; setting of preset assignments on the associated one of the audio playback devices 110; and transport control (play/pause, etc.) of the associated audio playback device.

The server 140 is a cloud-based server which contains (e.g., within an account database) information related to a user's audio system account. This includes user account information such as the list of the audio playback devices 110 within the system 100, device diagnostic information, preset assignments, etc. The server 140 will be connected to by the audio playback devices 110 and by the controllers 130 (e.g., by primary network controllers) for the purpose of preset management, as well as management of audio sources 120 and management of the user's audio system account. Generally, the controllers 130 (e.g., network controllers 130a, 130b) will login to the server 140 with a user's login details and ‘sync down’ the required information to enable the user to have access to the components of the audio system without further requiring the user to individually log into specific components such as specific internet radio services.

The audio playback devices 110 and one or more of the controllers 130 are coupled to a local area network (LAN) 150. Other devices such as one or more of the digital audio sources (e.g., a network-attached storage (NAS) device 120b) may also be coupled to the LAN 150. The LAN 150 may be a wired network, a wireless network, or a combination thereof. In one example, the devices (e.g., audio playback devices 110 and controllers 130 (e.g., primary and secondary controllers 130a, 130b)) within the LAN 150 are wirelessly coupled to the LAN 150 based on an industry standard such as IEEE 802.11 b/g. The LAN 150 may represent a network within a home, an office, or a vehicle. In the case of a residential home, the audio playback devices 110 may be arranged in different rooms (e.g., kitchen, dining room, basement, etc.) within the home. The devices within the LAN 150 connect to a user supplied access point 170 (e.g., a router) and subsequently to a wide area network (WAN) 160 (e.g., the Internet) for communication with the other digital audio sources 120 (Internet based music services 120a) and the server 140.

In one embodiment, the audio playback devices 110 and one or more controllers 130 are configured to interface with other digital audio sources 120 to enable an entity to be created from the other digital audio sources based on each audio track in a collection of audio tracks selected for playback from the audio playback devices 110.

Notably, in one embodiment, the audio system 100 enables a collection of audio tracks to be selected for playback from a selected audio playback device 110. Example collections of audio content may include an audio compact disc or other logical grouping of audio tracks such as a playlist. Upon completion of playback of the collection of audio tracks, the audio system automatically enables additional audio content to be selected from a digital audio source 120 which is similar to the selected collection of audio content that has just ended. This additional audio content is forwarded by the digital audio source 120 to the audio playback device 110 that was playing the selected collection of audio content to create a virtual extension of the selected collection of audio content.

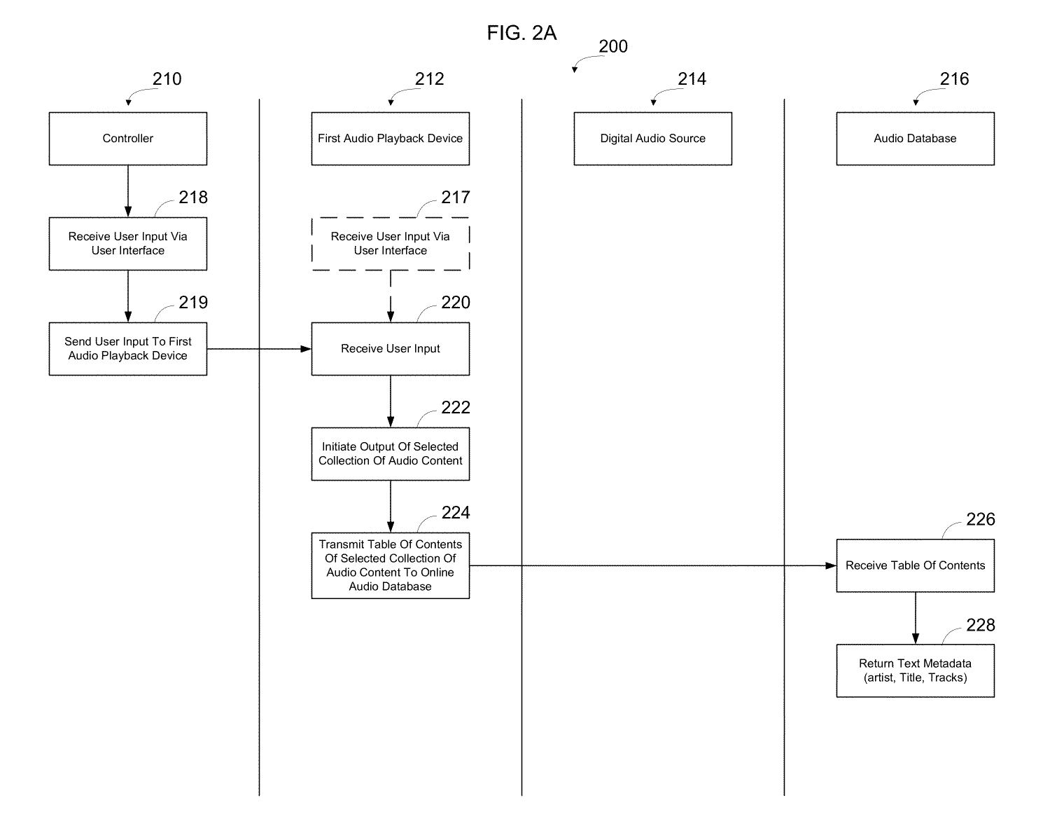

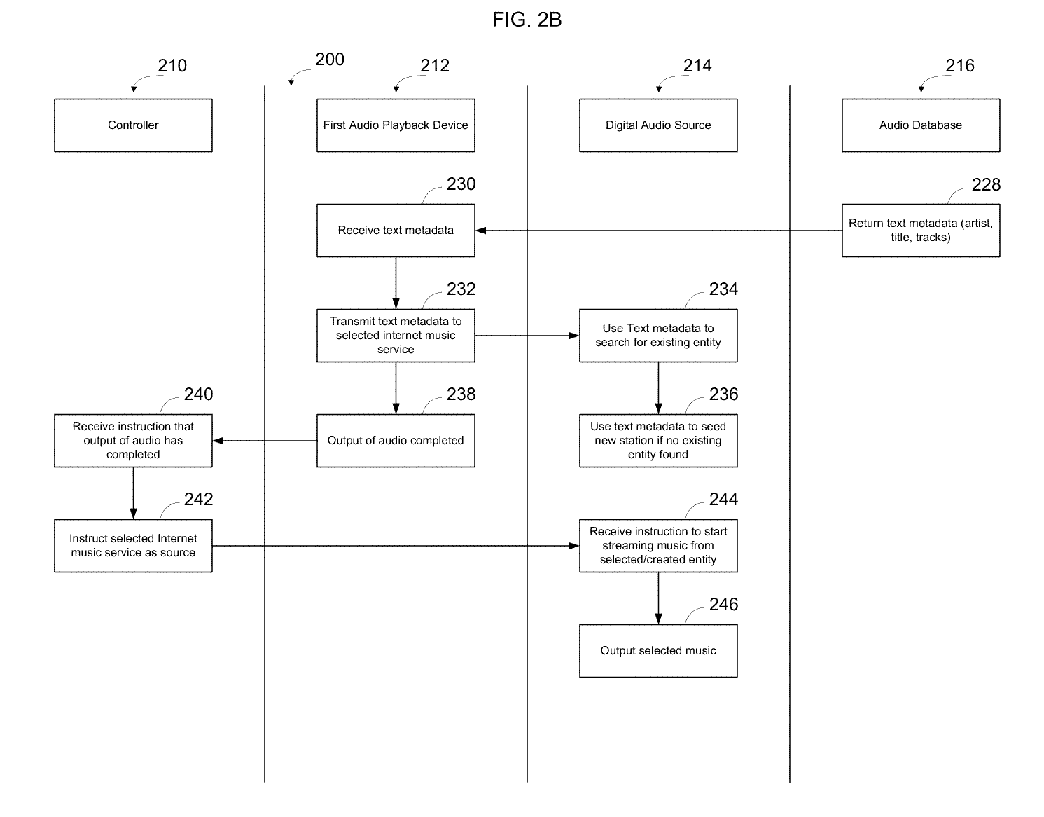

FIGS. 2A and 2B are a swim lane diagram 200 showing steps to enable a stream of content to be created from the other digital audio sources based on content of a collection of audio tracks selected for playback from a selected audio playback device 110. “Swim lane” diagrams may be used to show the relationship between the various “actors” in the processes and to define the steps involved in the processes. FIGS. 2A and 2B may equally represent a high-level block diagram of components of the invention implementing the steps thereof. The steps of FIGS. 2A and 2B may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network.

Referring to FIGS. 2A and 2B, four swim lanes are shown including a lane 210 for one of the controllers 130, a lane 212 for a first one of the audio playback devices 110, a lane 214 for the digital audio source 120, and a lane 216 for an audio database.

At step 220, a first audio playback device (i.e., a first one of the audio playback devices 110, FIG. 1) receives user input instructing the first audio playback device to initiate playback of a plurality of audio tracks forming a collection of audio content. In some cases, the user provides input directly to the audio playback devices, such as by pressing a button on the audio playback device (217). Alternatively, the user may provide input via a user interface on a selected one of the controllers (218), and the controller communicates the user input to the first audio playback device (219). Upon receipt of the input, the first audio playback device will initiate output of audio from the selected collection of audio content (222).

The collection of audio content may take the form of a commercially available audio compact disc, a plurality of audio tracks that have been saved to a physical storage medium such as a CD-ROM, or a plurality of audio tracks digitally stored in a storage medium and separated into a collection such as by designating the audio tracks as included in a playlist. Logical associations of audio tracks are conventionally referred to as “albums” and will be referred to herein as such.

In addition to initiating output of the audio content, the first audio playback device will collect and transmit a table of contents of the selected collection of audio content to an audio database (224). The audio database in one embodiment is an on-line database containing text metadata, including artist name, album title, and track information, for commercially purchased audio compact discs and commercially purchased digital albums. Currently, one example of an audio database that provides access to such information is a database maintained by Gracenote. Other audio databases may likewise be used or created to enable text metadata to be correlated with table of content information associated with the selected collection of audio content.

The first audio playback device reads the table of contents of the audio compact disc or otherwise obtains a table of content of the selected collection of audio content. The first audio playback device in one implementation forwards the Table of Contents to the audio database. In another implementation the first audio playback device forwards the table of contents to the controller which coordinates transmission of the table of content information to the audio database. The Table of Contents is typically implemented as a list that carries track information.

The audio database receives the table of contents (226) and uses this information to extract text metadata from the database associated with the selected collection of audio content. Where the selected collection of audio content is a purchased audio compact disc, the example text metadata may include the artist name, track title, and other track information. The text metadata is returned by the audio database (228). Depending on the implementation the text metadata may be returned to the first audio playback device, to the controller, or to the selected digital audio source.

Using an audio database to obtain text metadata about audio tracks included in the selected collection of audio content works well in connection with a store bought audio compact disc or downloadable album. However, for other collections of audio content such as a digital playlist of audio content or a user created physical medium containing user selected audio content, use of an audio database to obtain text metadata describing the content of the selected collection of audio content may not be feasible. In this instance, text metadata may be created by fingerprinting the selected collection of audio content to learn the track titles and artist names for the audio tracks included in the selected collection of audio content.

In an embodiment where the text metadata is returned to the first audio playback device, the first audio playback device receives the text metadata associated with the audio compact disc (230) and forwards the text metadata to the digital audio source (232). The first audio playback device may forward the text metadata to the digital audio source upon receipt, while playing the selected collection of audio content, or upon completion of playing of the selected collection of audio content, or at another point in time.

The digital audio source receives the text metadata and uses the text metadata (e.g. track titles and artist names) associated with all tracks of the selected collection of audio content to select an existing entity, such as an existing Internet radio station (234) or to create (seed) a new entity (236), e.g. to create a new Internet radio station. This enables a similar selection of music to be provided upon completion of playing of the selected collection of audio content. As an example, if the selected collection of audio content is a purchased audio compact disc and the digital audio source is an Internet Radio service such as Pandora, the text metadata associated with all audio tracks of the purchased audio compact disc currently being played by the first audio playback device may transmitted to Pandora and used as a seed in a song selection algorithm. This seed is used by Pandora to select an existing radio station that was previously created using the seed, or to enable Pandora to create a new Pandora radio station that is streamed to the first audio playback device when the audio compact disc has finished playing.

Transition between outputting, by the first audio playback device, from outputting content from the selected collection of audio content and content provided by the digital audio source may be implemented so that user input is not required to extend the content of the selected collection of audio content via the digital audio source. In this embodiment, the first audio playback device provides an indication to the digital audio source directly or via the controller when output of the selected collection of audio content has been completed or is about to end (238). When the controller receives this indication (240) it instructs the digital audio source to initiate streaming audio (242). Alternatively the first audio playback device may instruct the digital audio source directly by skipping steps 240, 242. Upon receipt of the instructions (244) the digital audio source will initiate streaming of a selection of audio tracks on the entity selected or created based on the text metadata of each track of the of the selected collection of audio content previously provided by the first audio playback device (246).

By enabling all tracks of a selected collection of audio content to be learned and used to select an existing entity such as an Internet radio station or to seed a new entity such as an Internet radio station at the digital audio source, it is possible to extend the audio content of the selected collection of audio content to include other similar tracks without requiring the user to interact with the audio system. Specifically, the user simply instructs, via the controller or via the first audio playback device, for the selected collection of audio content to be played. Optionally the user may be provided with an option while the selected collection of audio content is starting or while the selected collection of audio content is playing to extend the selected collection of audio content using the digital audio source as discussed herein. In connection with playing audio from the selected collection of audio content, the audio system obtains information about the album tracks and interacts with the other audio playback device to transition from outputting the selected collection of audio content to outputting content provided by the digital audio source automatically upon completion of the selected collection of audio content. In an embodiment where the selected collection of audio content is implemented as an audio compact disc and the digital audio source is an Internet music service, this enables automatic streaming of audio tracks by the Internet music service which are related to the content of the audio compact disc when the audio compact disc is over.

There are many ways of allocating responsibility for transitioning between local content available to the first audio playback device and content available from the digital audio source. In one embodiment, the controller 210 is responsible for obtaining the text metadata about the selected collection of audio content, forwarding the text metadata to the digital audio source, and initiating the handover between the first audio playback device and the digital audio source. In another embodiment, the first audio playback device is responsible for receiving the text metadata and transitioning to the digital audio source upon completion of the selected collection of audio content. Other ways of dividing responsibility between the components may likewise be implemented.

The user interface to the audio system may enable controls to be made available to enable the user to interact with the first audio playback device or with the digital audio source, depending on which device is providing the audio content. If a different set of controls is required to enable the user to interact with the digital audio source than with the first audio playback device, the controls available on the user interface may be automatically updated in connection with the transition from the first audio playback device to the digital audio source. Example controls available via the user interface for interaction with the first audio playback device may include transport control (e.g., play/pause, fast forward/rewind, etc.). Example controls available via the user interface for interaction with the digital audio source may include transport control as well as like and dislike controls to enable the user to provide feedback to the audio selection algorithm utilized by the digital audio source.

When the digital audio source receives the text metadata associated with audio tracks of the audio compact disc, it will use the metadata to determine if there is an already created entity, e.g. radio station, that should be selected (234). In this embodiment, the text metadata is used as a seed for the radio station. A given digital audio source will only create one entity from a given seed. If an entity has previously been created based on the text metadata (seed) that previously created entity will be selected. If an entity has not previously been created based on the text metadata (seed) a new entity will be created. Accordingly, upon receipt of instructions to initiate streaming music (244) the digital audio source will output audio tracks selected using the trained algorithm associated with the previously created entity (246) if the text metadata matches a seed previously used to create an entity. If the digital audio source is not able to find a suitable entity based on the received text metadata associated with the selected collection of audio content, a new entity will be created. Then, upon receipt of instructions to initiate streaming music (244) the digital audio source will output audio tracks selected using an audio track selection algorithm associated with the newly created entity (246).

In either event, when an entity is activated at the digital audio source, it will be added to a list of recent stations for the user. The list of recent stations may be stored on the server 140 or elsewhere in the audio system. The “recents list” (a/k/a “recents”) is a list of entities that is populated from content that the user has chosen to play. Recent entities can include Internet radio stations (e.g., for Pandora® and vTuner®), and a “group of tracks” selected for Spotify® and stored music. The “group of tracks” is a “parent” of a currently playing track, based on whatever the user either browsed to or searched for (e.g., Album, Playlist, Genre>All, Artist>All, etc.). The controllers 130, and, in some cases, the audio playback devices 110, can provide access to the recents by displaying the recents list to the user and allowing the user to browse the recents list and select entities therefrom.

Audio Playback Devices

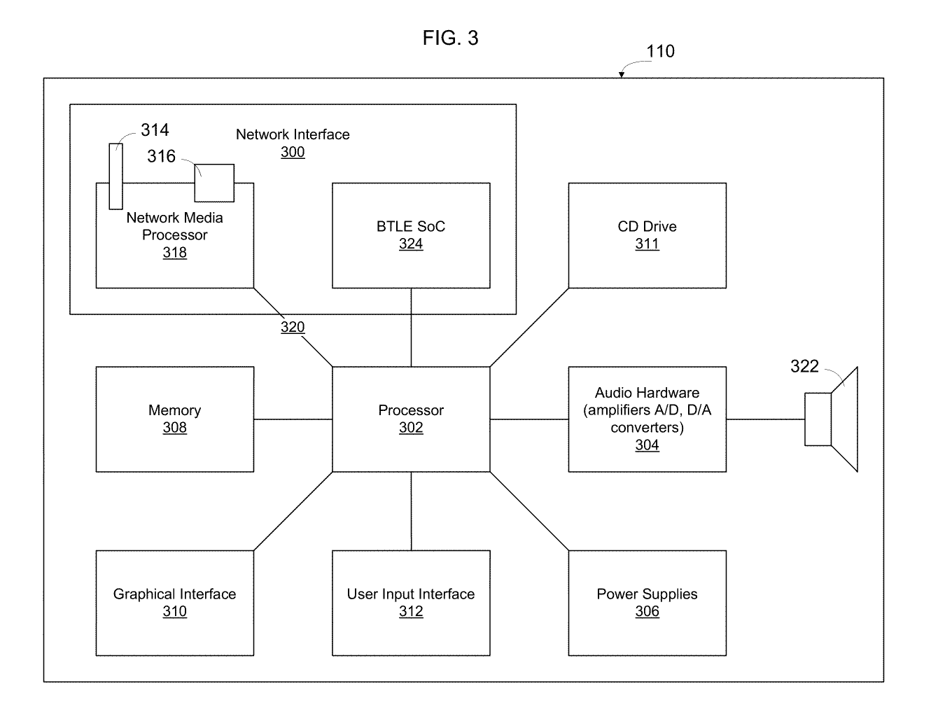

An example audio playback device 110 will now be described in greater detail with reference to FIG. 3. As shown in FIG. 3, the audio playback device 110 includes a network interface 300, a processor 302, audio hardware 304, power supplies 306 for powering the various audio playback device components, memory 308, graphical interface 310, CD drive 311, and user input interface 312. Each of the network interface 300, processor 302, audio hardware 304, power supplies 306, memory 308, graphical interface 310, CD drive 311, and user input interface 312 are interconnected using various buses, and several of the components may be mounted on a common motherboard or in other manners as appropriate.

The network interface 300 provides for communication between the audio playback device 110 and the controller (e.g., items 130a-c, FIG. 1), the server (item 140, FIG. 1), audio databases, the audio sources (items 120, FIG. 1), and other audio playback devices 110 via one or more communications protocols. The network interface 300 may provide either or both of a wireless interface 314 and a wired interface 316. The wireless interface 314 allows the audio playback device 110 to communicate wirelessly with other devices in accordance with a communication protocol such as such as IEEE 802.11 b/g. The wired interface 316 provides network interface functions via a wired (e.g., Ethernet) connection.

In some cases, the network interface 300 may also include a network media processor 318 for supporting Apple AirPlay® (a proprietary protocol stack/suite developed by Apple Inc., with headquarters in Cupertino, Calif., that allows wireless streaming of audio, video, and photos, together with related metadata between devices). For example, if a user connects an AirPlay® enabled device, such as an iPhone or iPad device, to the LAN 150, the user can then stream music to the network connected audio playback devices 110 via Apple AirPlay®. A suitable network media processor is the DM870 processor available from SMSC of Hauppauge, N.Y. The network media processor 318 provides network access (i.e., the Wi-Fi network and/or Ethernet connection can be provided through the network media processor 318) and AirPlay® audio. AirPlay® audio signals are passed to the processor 302, using the I²S protocol (an electrical serial bus interface standard used for connecting digital audio devices), for downstream processing and playback. Notably, the audio playback device 110 can support audio-streaming via AirPlay® and/or DLNA's UPnP protocols, and all integrated within one device.

All other digital audio coming from network packets (e.g. digital audio from digital audio source 120) comes straight from the network media processor 318 through a USB bridge 320 to the processor 302 and runs into the decoders, DSP, and other components of audio hardware 304, and eventually is played back (rendered) via the electro-acoustic transducer(s) 322.

The network interface 300 can also include a Bluetooth Low Energy (BTLE) system-on-chip (SoC) 324 for Bluetooth low energy applications (e.g., for wireless communication with a Bluetooth enabled controller (item 130c, FIG. 1)). A suitable BTLE SoC is the CC2540 available from Texas Instruments, with headquarters in Dallas, Tex.

Streamed data pass from the network interface 300 to the processor 302. The processor 302 can execute instructions within the audio playback device (e.g., for performing, among other things, digital signal processing, decoding, and equalization functions), including instructions stored in the memory 308. The processor 302 may be implemented as a chipset of chips that include separate and multiple analog and digital processors. The processor 302 may provide, for example, for coordination of other components of the audio playback device 110, such as control of user interfaces, and applications run by the audio playback device 110. A suitable processor is the DA921 available from Texas Instruments.

The processor 302 provides a processed digital audio signal to the audio hardware 304 which includes one or more digital-to-analog (D/A) converters for converting the digital audio signal to an analog audio signal. The audio hardware 304 also includes one or more amplifiers which provide amplified analog audio signals to the electroacoustic transducer(s) 322 for playback. In addition, the audio hardware 304 may include circuitry for processing analog input signals to provide digital audio signals for sharing with other devices in the audio system 100.

The memory 308 stores information within the audio playback device 110. In this regard, the memory 308 may information related to the selected collection of audio content discussed above. Specifically, the memory 308 may contain one or more application programs to enable access to the audio database and to enable transition from outputting the selected collection of audio content to outputting audio received from the other audio playback device as discussed above. For example, in one embodiment the one or more application programs are configured to play an audio disc inserted into the CD drive 311 and, upon completion of the tracks on the audio disc, continuing streaming audio from a digital audio source entity selected based on the content of the audio disc.

In some cases, when setting up the digital audio sources, the user may be prompted to enter account credentials. For example, when adding a user's Pandora® account to the user's system account, the Pandora® Internet service may request account credentials from the user. In return, Pandora® will return a unique identifier (“token”) that can be stored on the server and in memory on each of the audio playback devices and which will allow the audio playback devices subsequent access to the digital audio source without requiring login each time.

The memory 308 may store account information and also provide storage for “tokens” for facilitating single press access to the digital audio sources 120 (e.g., the Internet radio services of FIG. 1). A token, as used herein, is a unique identifier that may be provided by the digital audio source 120 and which allows the digital audio source 120 to recognize the audio playback device 110 as being associated with a user's account with the digital audio source 120 and without requiring the user to enter credentials (e.g., user name, password, etc.) each time the audio playback device 110 attempts to access the digital audio source 120. This facilitates transition from the selected collection of audio content to the digital audio source when the first audio device has finished playing the selected collection of audio content.

The memory 308 may include, for example, flash memory and/or non-volatile random access memory (NVRAM). In some implementations, instructions (e.g., software) are stored in an information carrier. The instructions, when executed by one or more processing devices (e.g., the processor 302), perform one or more processes, such as those described above (e.g., with respect to FIGS. 2A, 2B). The instructions can also be stored by one or more storage devices, such as one or more computer- or machine-readable mediums (for example, the memory 308, or memory on the processor). The instructions may include instructions for performing decoding (i.e., the software modules include the audio codecs for decoding the digital audio streams), as well as digital signal processing and equalization.

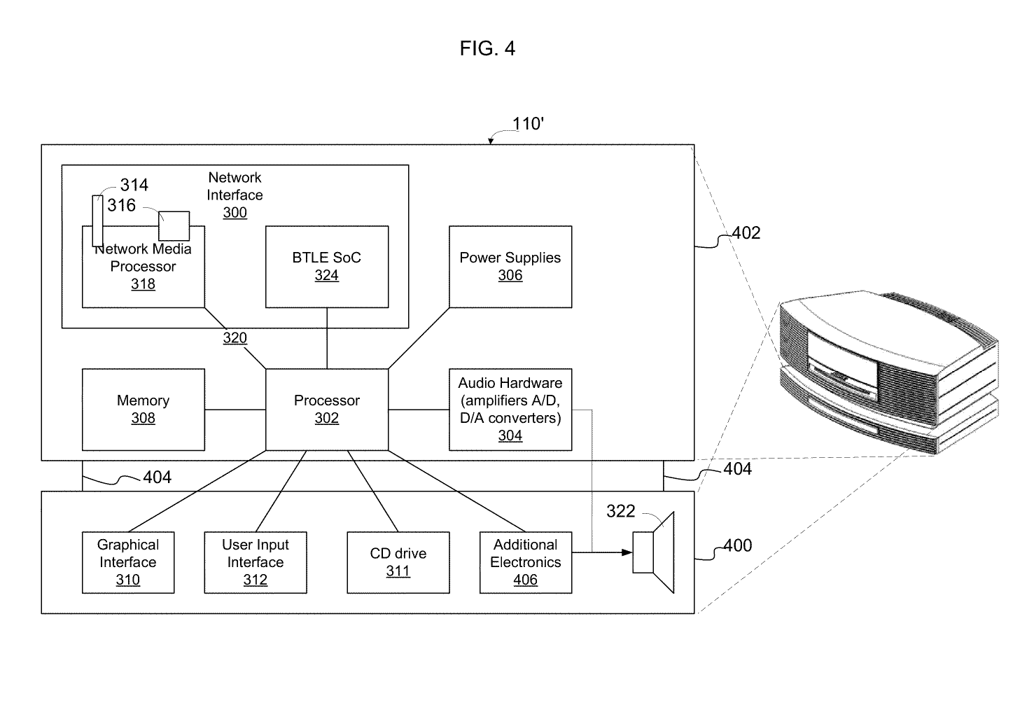

FIG. 4 illustrates another implementation of an audio playback device 110′ in which the audio playback device hardware is divided between an enclosure 400 and a separate device (“dongle 402”). The dongle 402 can be connected to the enclosure 400 via a wired connection 404. In the illustrated example of FIG. 4, the network interface 300, the processor 302, the audio hardware 304, the power supplies 306, and memory 308 are located within a housing of the dongle 402. The graphical interface 310, CD drive 311, and the user input interface 312 are located on the enclosure 400. The enclosure 400 encloses the electro-acoustic transducer(s) 322 and may also include additional electronics 406 (e.g., processors, amplifiers, D/A converters, A/D converters, power supplies, etc.) for processing, converting and amplifying audio content from local audio sources (e.g., audio content stored in memory within the enclosure 400, a CD inserted into the CD drive 311, a portable music device such as an IPod connected to the audio playback device 110′, etc.).

Controllers

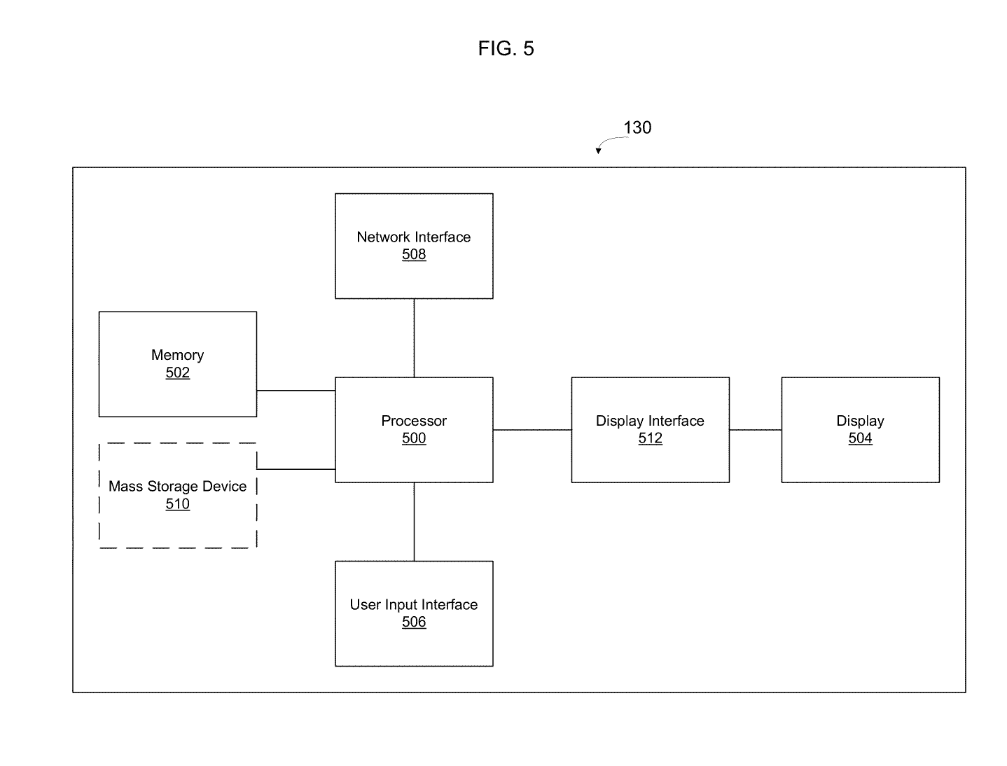

Referring to FIG. 5, an example controller 130 includes a processor 500, a memory 502, a display 504, a user input interface 506, and a network interface 508, among other components. The controller 130 may also be provided with a mass storage device 510, such as a hard drive, a micro-drive, or other device, to provide additional storage. Each of the processor 500, memory 502, display 504, user input interface 506, and network interface 508 are interconnected using various buses, and several of the components may be mounted on a common motherboard or in other manners as appropriate.

The processor 500 can execute instructions (e.g., software) within the controller 130, including instructions stored in the memory 502 or in a secondary storage device (e.g., mass storage device 510). The processor 500 may be implemented as a chipset of chips that include separate and multiple analog and digital processors. The processor 500 may provide, for example, for coordination of other components of the controller 130, such as control of user interfaces, applications run by the controller 130, and network communication by the controller 130. The processor 500 may communication with a user through the display 504 and the user input interface 506.

The processor 500 may communicate with the user through a display interface 512 coupled to the display 504. The display 504 may include an LCD monitor, or a touch sensitive display (e.g., in the case of a mobile device). The display interface 512 may comprise appropriate circuitry for driving the display 504 to preset graphical and other information to the user.

The user input interface 506 may include one or more user input devices such as a keyboard, a pointer device such as a mouse, and/or a touch sensitive display. In some cases, the same device (e.g., a touch sensitive display) may be utilized to provide the functions of the display 504 and the user input interface 506.

The network interface 508 facilitates wireless communication (e.g., Wi-Fi, Bluetooth, IR, etc.) with one or more of the audio playback devices (item 110, FIG. 1) via a corresponding network interface (item 300, FIG. 3) on the audio playback device 110.

The memory 502 stores information within the controller 130. In some implementations, the memory 502 is a volatile memory unit or units. In some implementations, the memory 502 is a non-volatile memory unit or units. The memory 502 may also be another form of computer-readable medium, such as magnetic or optical disk.

The mass storage device 510 is capable of providing mass storage for the controller 130. In some implementations, the mass storage device 510 may be or contain a computer readable medium, such as a floppy disk device, a hard disk device, an optical disk device, or a tape device, a flash memory or other similar solid state memory device, or an array of devices.

Instructions (e.g., software) can be stored in an information carrier. The instructions, when executed by one or more processing devices (e.g., the processor 500), perform one or more processes, such as those described above (e.g., with reference to FIGS. 2A and 2B). The instructions can also be stored by one or more storage devices such as computer- or machine-readable mediums (for example, the memory 502, the mass storage device 510, or memory in the processor 500).

Server

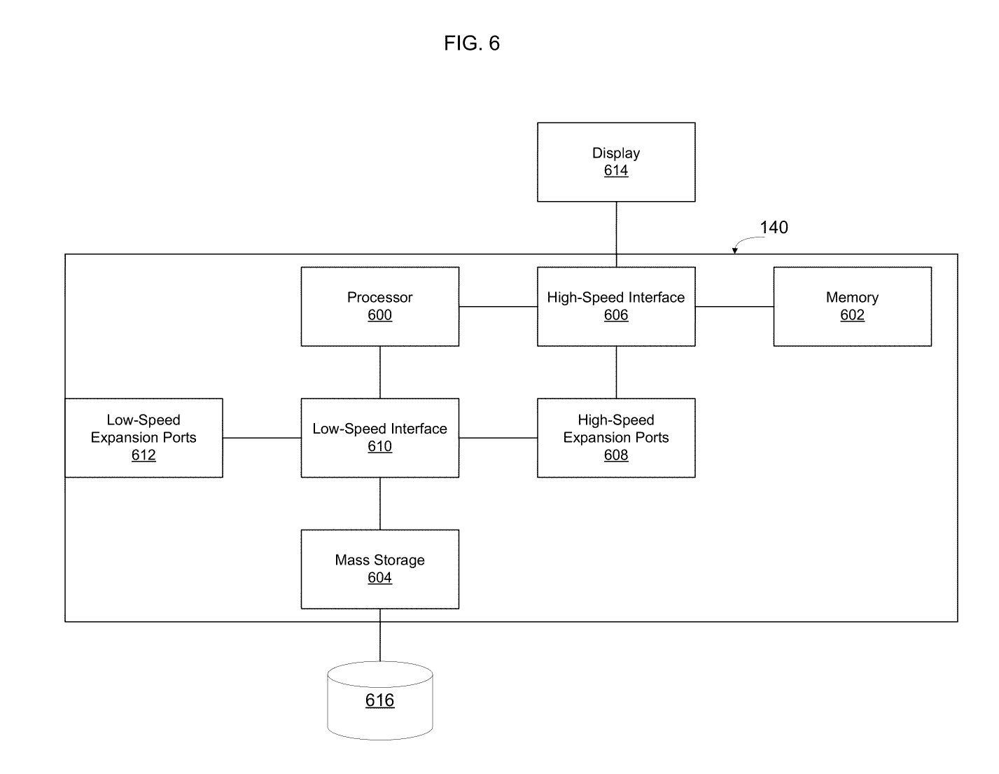

FIG. 6 illustrates an example computing device that can be utilized to implement the server (item 140, FIG. 1). The computing device is intended to represent various forms of digital computers, such as servers, blade servers, mainframes, and other appropriate computers. The components shown here, their connections and relationships, and their functions, are meant to be examples only, and are not meant to be limiting.

The computing device 140 includes a processor 600, a memory 602, a mass storage device 604, a high-speed interface 606 connecting to the processor 600, memory 602, and multiple high-speed expansion ports 608, and a low-speed interface 610 connecting to the processor 600, the mass storage device 604, and to a low-speed expansion port 312. Each of the processor 600, the memory 602, the storage device 604, the high-speed interface 606, the high-speed expansion ports 608, and the low-speed interface 610 are interconnected using various busses, and may be mounted on a common motherboard or in other manners as appropriate. The processor 600 can process instructions (e.g., a software program) for execution within the computing device 140, including instructions stored in the memory 602 or on the storage device 604 to display graphical information for a GUI on an external input/output device, such as a display 614 coupled to the high-speed interface 606. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 602 stores information within the computing device 140. In some implementations, the memory 602 is a volatile memory unit or units. In some implementations, the memory 602 is a non-volatile memory unit or units. The memory 602 may also be another form of computer-readable medium, such as a magnetic or optical disk.

The storage device 604 is capable of providing mass storage for the computing device 140. In some implementations, the storage device 604 may be or contain a computer-readable medium, such as a floppy disk device, a hard disk device, an optical disk device, a tape device, a flash memory or other similar solid state memory device, or an array of devices, including devices in a storage area network or other configurations. Instructions can be stored in an information carrier. The instructions, when executed by one or more processing devices (for example, processor 600), perform one or more processes, such as those described above (e.g., with reference to FIGS. 2A-2B). The instructions can also be stored by one or more storage devices such as computer-readable mediums (for example, the memory 602, the storage device 604, or memory on the processor 600). The storage device 604 may provide storage for a database 616. The database can be used to store audio system account information and other information used by the audio system.

The high-speed interface 606 manages bandwidth-intensive operations for the computing device 140, while the low-speed interface 612 manages lower bandwidth-intensive operations. Such allocation of functions is an example only. In some implementations, the high-speed interface 606 is coupled to the memory 602, the display 614 (e.g., through a graphics processor or accelerator), and to the high-speed expansion ports 608, which may accept various expansion cards (not shown). In the implementation, the low-speed interface 610 is coupled to the storage device 604 and the low-speed expansion port 612. The low-speed expansion port 612, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 140 may be implemented in a number of different forms. For example, it may be implemented as a standard server, or multiple times in a group of such servers. It may also be implemented as part of a rack server system.

Implementations of the systems and methods described above comprise computer components and computer-implemented steps that will be apparent to those skilled in the art. For example, it should be understood by one of skill in the art that the computer-implemented steps may be stored as computer-executable instructions on a computer-readable medium such as, for example, floppy disks, hard disks, optical disks, Flash ROMS, nonvolatile ROM, and RAM. Furthermore, it should be understood by one of skill in the art that the computer-executable instructions may be executed on a variety of processors such as, for example, microprocessors, digital signal processors, gate arrays, etc. In addition, the instructions may be implemented in a high-level procedural and/or object-oriented programming language, and/or in assembly/machine language. For ease of exposition, not every step or element of the systems and methods described above is described herein as part of a computer system, but those skilled in the art will recognize that each step or element may have a corresponding computer system or software component. Such computer system and/or software components are therefore enabled by describing their corresponding steps or elements (that is, their functionality), and are within the scope of the disclosure.

A number of implementations have been described. Nevertheless, it will be understood that additional modifications may be made without departing from the scope of the inventive concepts described herein, and, accordingly, other implementations are within the scope of the following claims.

What is claimed is:

1. A method for creating a stream of content for an audio system, the method comprising:
obtaining text metadata identifying each audio track of a selected collection of audio content, the selected collection of audio content being selected for playback from an audio playback device of the audio system, the selected collection of audio content being implemented as an audio compact disc that has been selected for playback via the audio system;
forwarding the text metadata identifying each audio track of the selected collection of audio content to a digital audio source to enable the digital audio source to select additional audio content based on the text metadata for playback from the audio playback device.

2. The method of claim 1, wherein the digital audio source is an Internet music service.

3. The method of claim 1, wherein the text metadata includes a title of the audio compact disc, and track information for each audio track on the audio compact disc.

4. The method of claim 3, wherein the text metadata includes a track title and artist name for each audio track on the audio compact disc.

5. The method of claim 1, further comprising forwarding a table of content of the collection of audio tracks to an audio database; and
receiving, from the audio database, the text metadata.

6. The method of claim 1, further comprising fingerprinting the selected collection of audio content to determine track tiles and artist names of each of the plurality of audio tracks.

7. The method of claim 1, wherein the step of forwarding the text metadata identifying each audio track of the selected collection of audio content to a digital audio source occurs prior to completion of playing each audio track of the selected collection of audio content.

8. The method of claim 1, further comprising receiving, by the audio playback device from the digital audio source, the additional audio content.

9. The method of claim 8, further comprising outputting audio associated with each audio track of the selected collection of audio content; and
after completing the step of outputting the audio associated with each audio track of the selected collection of audio content, outputting audio associated with the additional audio content received from the digital audio source.

10. A method for creating a stream of content for an audio system, the method comprising:
obtaining text metadata identifying each audio track of a selected collection of audio content, the selected collection of audio content being selected for playback from an audio playback device of the audio system, the selected collection of audio content being implemented as a playlist of audio tracks defined by a user of the audio system that has been selected for playback from the audio playback device; and
forwarding the text metadata identifying each audio track of the selected collection of audio content to a digital audio source to enable the digital audio source to select additional audio content based on the text metadata for playback from the audio playback device.

11. The method of claim 10, further comprising fingerprinting the selected collection of audio content to determine track tiles and artist names of each of the plurality of audio tracks.

12. An audio playback device configured to operably connect to a digital audio source, the audio playback device comprising:
a digital-to-analog converter configured to receive a digital representation of content and convert the digital representation of the content into analog form;
an electro-acoustic transducer configured to generate audible sound from the analog form;
a processor; and
instructions stored on a computer-readable media that, when executed, cause the processor to:
cause a digital representation of a plurality of audio tracks of a selected collection of audio content to be input to the digital-to-analog converter; and
after each audio track of the selected collection of audio content is input to the digital-to-analog converter, cause additional audio content received from a digital audio source to be input to the digital-to-analog converter;
wherein the additional audio content is selected by the digital audio source based on each of the plurality of tracks of the selected collection of audio content.

14. The audio playback device of claim 13, wherein the instructions are further configured to cause the processor to:
obtain text metadata identifying each audio track of the selected collection of audio content; and
forward the text metadata identifying each audio track of the selected collection of audio content to the digital audio source to enable the digital audio source to select the additional audio content based on the text metadata.

13. The audio playback device of claim 12, wherein the digital audio source is an Internet music service.

14. The audio playback device of claim 12, wherein the selected collection of audio content is an audio compact disc that has been selected for playback via the audio playback device.

15. The audio playback device of claim 12, wherein the text metadata includes a title of the audio compact disc, and track information for each audio track on the audio compact disc.

16. The audio playback device of claim 12, wherein the text metadata includes a track title and artist name for each audio track on the audio compact disc.

17. The audio playback device of claim 12, wherein the selected collection of audio content is a playlist of audio tracks defined by a user of the audio playback device that has been selected for playback from the audio playback device.

18. The audio playback device of claim 12, further comprising instructions to cause the processor to forward a table of content of the collection of audio tracks to an Audio Database; and
receive, from the Audio Database, the text metadata.
